(19) United States
(12) Patent Application Publication
(10) Pub. No.: US 2022/0030967 A1
(43) Pub. Date: Feb. 3, 2022

(54) Mask Scenting Systems and Methods

(71) Applicant: Jennifer Bowie, Trinidad, CO (US)

(72) Inventor: Jennifer Bowie, Trinidad, CO (US)

(21) Appl. No.: 17/388,657

(22) Filed: Jul. 29, 2021

Related U.S. Application Data
(60) Provisional application No. 63/058,048, filed on Jul. 29, 2020.

(51) Int. Cl. A41D 13/11; C11B 9/00

(52) U.S. Cl. CPC A41D 13/11; A41D 2400/36; C11B 9/008; C11B 9/0034

(57) ABSTRACT

Systems and methods for scenting masks for providing a scent to a user include a mask system having a mask with an interior surface, an exterior surface, a right ear loop, and a left ear loop. Mask systems can also include a scenting assembly having a scented portion and an adhesive portion, where the scented portion includes an absorbent patch impregnated with a scented substance. The adhesive portion of the scenting system can be attached with the interior surface of the mask, such that when the mask system is worn by the user, aromatic molecules of the scented substance exit the absorbent patch and flow into the user's nose without the scented substance touching the user's skin.

### CROSS-REFERENCES TO RELATED APPLICATIONS

This application claims the benefit of U.S. Provisional Patent Application No. 63/058,048 filed Jul. 29, 2020, the disclosure of which is incorporated herein by reference.

### BACKGROUND OF THE INVENTION

Embodiments of the present invention relate to the field of masks, and in particular embodiments, to systems and methods for scenting masks.

Masks, such as surgical masks or face masks, are used to protect individuals from exposure to pathogens, pollutants, and other harmful particulates. Although current mask designs are efficient in providing protection, still further improvements are desired. Embodiments of the present invention provide solutions to at least some of these outstanding needs.

### BRIEF SUMMARY OF THE INVENTION

Embodiments of the present invention include mask scenting systems and methods that can be used to improve the performance of masks.

In one aspect, embodiments of the present invention encompass mask scenting system having a scented portion, an adhesive material, and a removable backing section.

In another aspect, an exemplary mask system for providing a scent to a user can include a mask and a scenting assembly. The mask can have an interior surface, an exterior surface, a right ear loop, and a left ear loop. The scenting assembly can include a scented portion and an adhesive portion. The scented portion can include an absorbent patch impregnated with a scented substance. The adhesive portion of the scenting system can be attached with the interior surface of the mask, such that when the mask system is worn by the user, aromatic molecules of the scented substance exit the absorbent patch and flow into the user's nose without the scented substance touching the user's skin. In some cases, the scented substance includes an essential oil. In some cases, the scented substance includes an orange scent. In some cases, the scented substance includes limonene. In some cases, the scented substance includes D-limonene. In some cases, the scented substance includes a material having a grapefruit scent. In some cases, the scented substance includes a material having a peppermint scent. In some cases, the scented substance includes menthol. In some cases, the scented substance includes menthone. In some cases, the scented substance includes a material having a eucalyptus scent. In some cases, the scented substance includes eucalyptol. In some cases, the scented substance includes alpha-terpineol. In some cases, the scented substance includes a floral scent. In some cases, the scented substance comprises a plant-based scent. In some cases, the scented substance is present in the absorbent patch in a predetermined amount.

In still another aspect, embodiments encompass methods for providing a scent to a user. Exemplary methods can include removing a scenting system from a package, where scenting system includes an interior scented portion, a backing section, and an adhesive portion disposed between the interior scented portion and the backing section, and where the interior scented portion includes an absorbent patch impregnated with a scented substance. Methods can also include removing the backing section from the adhesive portion of the scenting system, and contacting the adhesive portion of the scenting system to an interior surface of a mask. The mask can have a right ear loop and a left ear loop. Methods can also include placing the right ear loop about the user's right ear and the left ear loop about the user's right ear, with the interior surface of the mask facing toward the user's face, such that aromatic molecules of the scented substance exit the absorbent patch and flow into the user's nose without the scented substance touching the user's skin, thereby providing the scent to the user. In some embodiments, the scented substance includes an essential oil. In some embodiments, the scented substance is present in the absorbent patch in a predetermined amount.

In yet another aspect, embodiments encompass scenting systems for a face mask. Exemplary scenting systems include a scented portion, a backing portion, and an adhesive portion disposed between the scented portion and the backing portion. In some cases, the scented portion includes an absorbent patch impregnated with a scented substance. In some cases, the scented substance includes an orange scent, a grapefruit scent, a peppermint scent, or a eucalyptus scent.

### BRIEF DESCRIPTION OF THE DRAWINGS

FIG. 1 depicts an exemplary mask system for providing a scent to a user, according to embodiments of the present invention.

FIG. 2 provides a partial side view of a scenting system, according to embodiments of the present invention.

FIG. 3 provides a close-up view of a scenting system, according to embodiments of the present invention.

FIG. 3A illustrates aspects of scenting systems, according to embodiments of the present invention.

FIG. 4 depicts a scenting system contained within a package, according to embodiments of the present invention.

FIG. 5 depicts exemplary embodiments of a scenting system and various packaging options, according to embodiments of the present invention.

FIG. 6 depicts scenting systems provided in variety of shapes, according to embodiments of the present invention.

FIG. 7 depicts an exemplary mask system for providing a scent to a user, according to embodiments of the present invention.

FIG. 8 depicts aspects of a method for providing a scent to a user, according to embodiments of the present invention.

### DETAILED DESCRIPTION OF THE INVENTION

All illustrations of the drawings are to be describing selected embodiments of the present invention and are not intended to limit the scope of the present invention. All references of user or users pertain to either individual or individuals who would utilize embodiments of the present invention.

Embodiments of the present invention encompass mask scenting systems for attachment with a mask or other mouth and/or nose covering device. Mask scenting systems can give off a scent to cover up or eliminate unwanted odors. Mask scenting systems can be packaged in product packaging so that the mask scenting system does not dry out or lose its scent.

Advantageously, the scenting systems and methods disclosed herein enable the individual (e.g. healthcare worker) to tolerate undesirable odors while providing quality care in their service or performing other tasks. In the healthcare setting, the scenting system can allow for increased tolerance and better care to patients when the healthcare provider uses the scenting system. The natural reaction to “hold one's breath” or to “work as quickly as possible” in order to get out of the situation can be decreased or eliminated. Use of the scenting system can make many difficult situations easier on the healthcare provider. In use, the mask can be worn by a health professional during a healthcare procedure. A mask may be worn by any other individual that desired protection from unwanted odors. The scenting system does not negatively impact the breathability or protective functionality of the mask.

In some embodiments, the scenting system can be used in various fields, including medical, dental, educational, diagnostic, research, law enforcement, personal consumer, and the like. In some embodiments, the scenting system can be used in various settings or locations, including hospitals, dental offices, mortuaries, physician's offices, laboratories, universities, nursing homes, residential homes, and in the field (e.g. by field workings, including EMS, fire, law enforcement, social work, and the like). Scenting systems can be used by persons performing autopsies or participating in cadaver examinations. Any healthcare worker of all scope of practice, lab technicians, researchers, law enforcement workers, and others, can use the scenting system in combination with a mask.

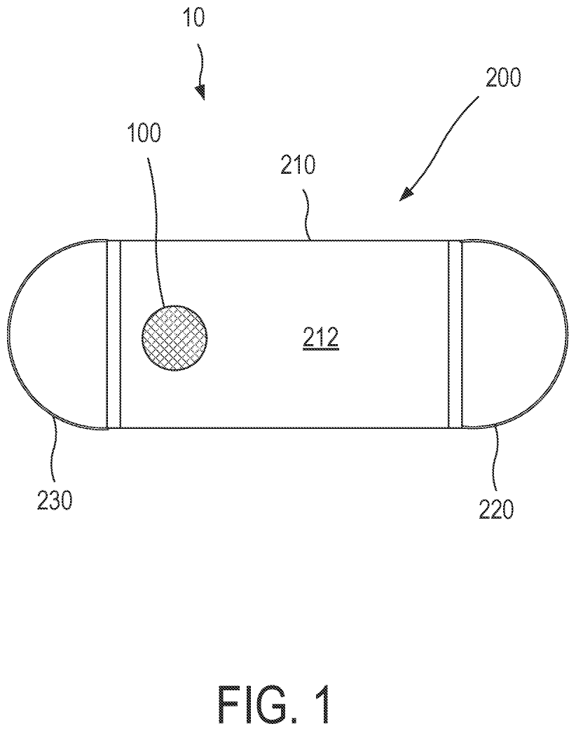

FIG. 1 depicts aspects of an exemplary mask system 10 for providing a scent to a user, according to embodiments of the present invention. As shown here, a mask system 10 can include a mask 200 having an interior surface, an exterior surface, a right ear loop, and a left ear loop. The mask system can also include a scenting assembly 100 having a scented portion and an adhesive portion, the scented portion comprising an absorbent patch impregnated with a scented substance. The adhesive portion of the scenting system can be attached with the interior surface of the mask, such that when the mask system is worn by the user, aromatic molecules of the scented substance exit the absorbent patch and flow into the user's nose without the scented substance touching the user's skin. In some cases, a scenting system 100 can be coupled with a mask 200. The mask 200 includes a breathing panel 210 having an interior surface 212 that faces toward the wearer and an exterior surface (not shown) that faces away from the wearer. The panel 210 is coupled with two ear loops 220, 230, which can be secured to the head of the wearer, for example by looping arounds the right and left ears. In some cases, ear loops may be replaced with head times, elastic straps, or the like. Ear loops 220, 230 are typically made of an elastic material or cord. As shown here, scenting system 100 has a circular shape. As discussed elsewhere herein, a scenting system can be provided in any of a variety of shapes.

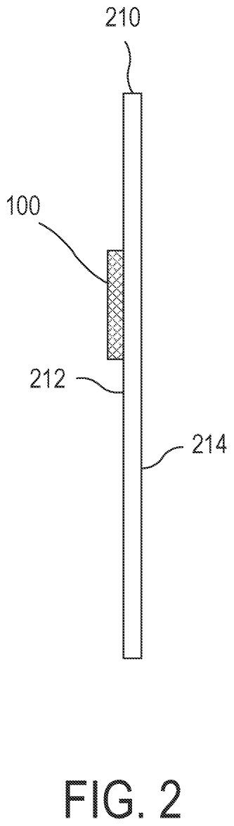

FIG. 2 provides a partial side view of the scenting system 100 attached with the panel 210. As shown here, the panel 210 includes an interior surface 212 and an exterior surface 214. The scenting system 100 can include an adhesive material that allows it to attach with the interior surface 212. In some cases, the scenting system 100 is reversibly attached with the panel 210.

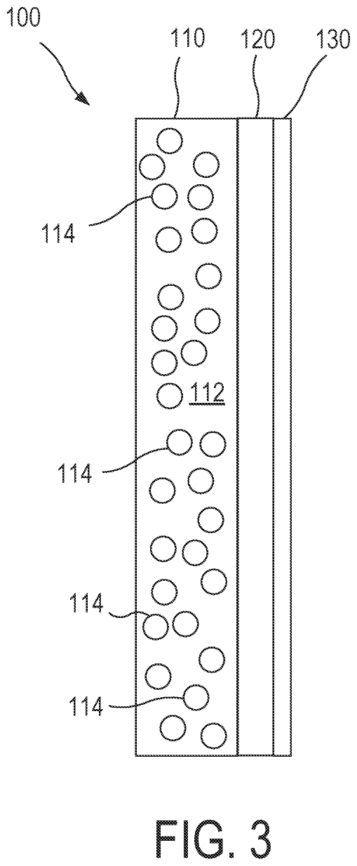

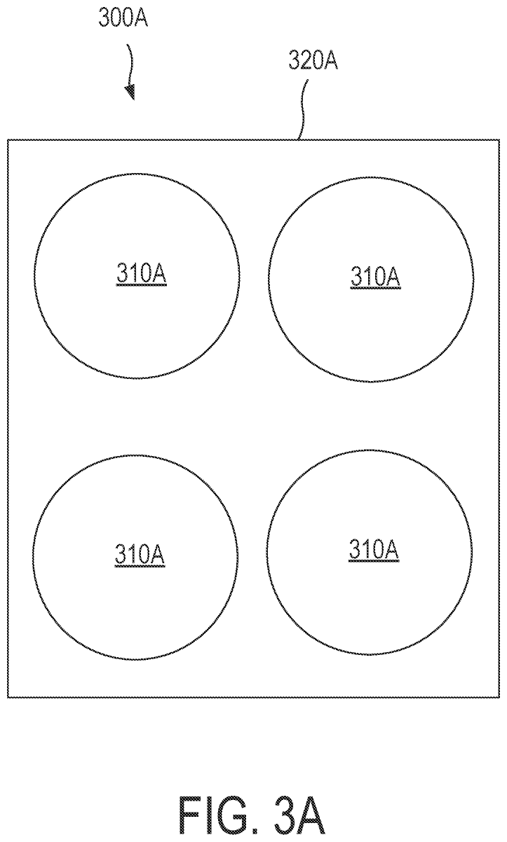

FIG. 3 provides a close-up view of a scenting system 100, according to embodiments of the present invention. As shown here, scenting system 100 includes an interior scented portion 110, an intermediate adhesive portion 120, and an exterior backing section 130. The interior scented portion 110 can include an absorbent patch 112 and a scented substance 114. As shown here, the scented substance 114 can be distributed throughout all or part of the absorbent patch 112. In some embodiments, patch 112 is an absorbent pad. In some embodiments, patch 112 is a felt pad. In some embodiments, interior scented portion 110 is a felt pad at least partially saturated or otherwise soaked or impregnated with a scented substance. In some cases, the backing section 130 may include plastic.

In some embodiments, scented substance 114 includes an essential oil. In some cases, scented substance 114 includes aromatic molecules. In some cases, scented substance 114 includes a material having an orange scent. In some cases, scented substance 114 includes limonene (e.g. D-limonene). In some cases, scented substance 114 includes a material having a grapefruit scent. In some cases, scented substance 114 includes a material having a peppermint scent. In some cases, scented substance 114 includes menthol and menthone. In some cases, scented substance 114 includes a material having a eucalyptus scent. In some cases, scented substance 114 includes eucalyptol and alpha-terpineol. In some cases, scented substance 114 can include any floral or plant-based scent, extraction, fragrance, or essence.

Advantageously, the scented portion 110 may include a predetermined or fixed amount of a scented substance 114. By providing a known or controlled amount of scented substance 114, it is possible to avoid providing the user with a patch 112 that is oversaturated, which may provide an overly strong scent and/or produce unwanted effects (e.g. burning sensation in nose and/or eyes of person wearing the mask).

In some cases, the adhesive portion 120 may include a Velcro-like material. In some cases, the adhesive portion may include a glue or sticky substance. In use, the adhesive portion allows the scented portion 110 to be secured in place relative to the mask panel.

In some cases, the scented substance 114 may be provided as an oil. In some cases, the patch 112 can be configured to allow aromatic molecules from the oil to exit the patch and flow into the nose of the person wearing the mask, without the oil touching the person's skin.

As shown in FIG. 3A, multiple adhesive portion—scented portion subassemblies 310A can be placed on a single backing portion 320A, thereby providing a scenting system 300A. The scenting system 300A can be placed within a pouch, as described elsewhere herein.

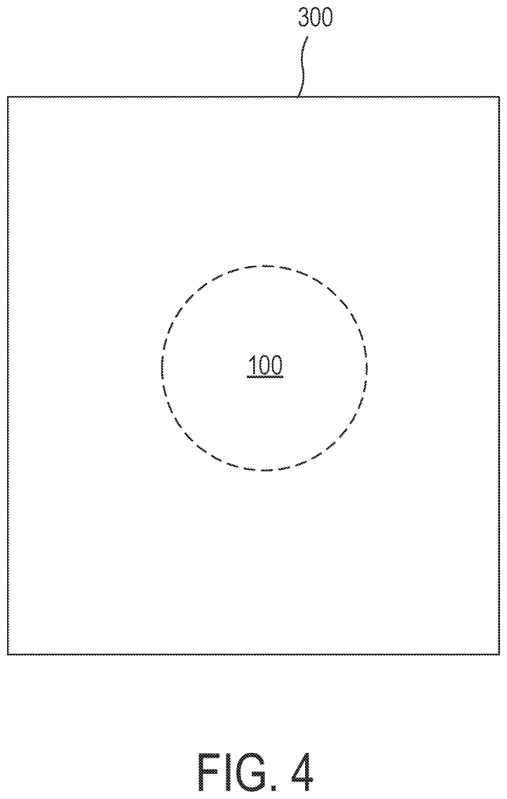

The scenting system 100 can be packaged within a package 300, as indicated by FIG. 4. In use, the individual can remove the system 100 from the package, and then remove the exterior backing section 130 from the adhesive portion 120, for example by peeling the exterior backing section 130 away from the adhesive portion 120. The individual can then press the adhesive portion 120 against the interior surface 212 of the mask panel 210, or otherwise contact the adhesive portion 120 to the interior surface 212 of the mask panel 210, so as to secure the scented portion 110 relative to the mask panel 210. In some cases, the package 300 is made of a plastic material. In some cases, the package 300 includes an outer paper section and an inner foil section. The package 300 can be airtight or otherwise configured to prevent air or fluid from leaking or exiting from the package during storage.

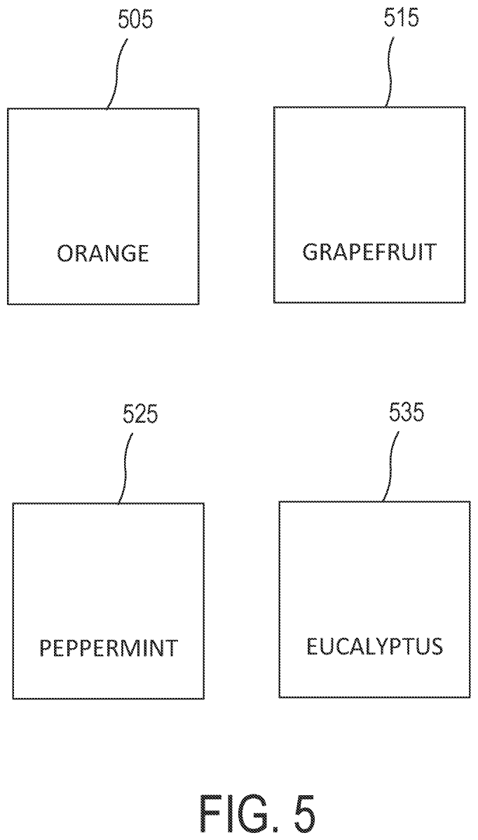

FIG. 5 depicts exemplary embodiments of a scenting system and various packaging options. For example, a packaged scenting system 505 can be providing in an orange scented embodiment. In some cases, a packaged scenting system 515 can be providing in a grapefruit scented embodiment. In some cases, a packaged scenting system 525 can be providing in a grapefruit scented embodiment. In some cases, a packaged scenting system 535 can be providing in a eucalyptus scented embodiment.

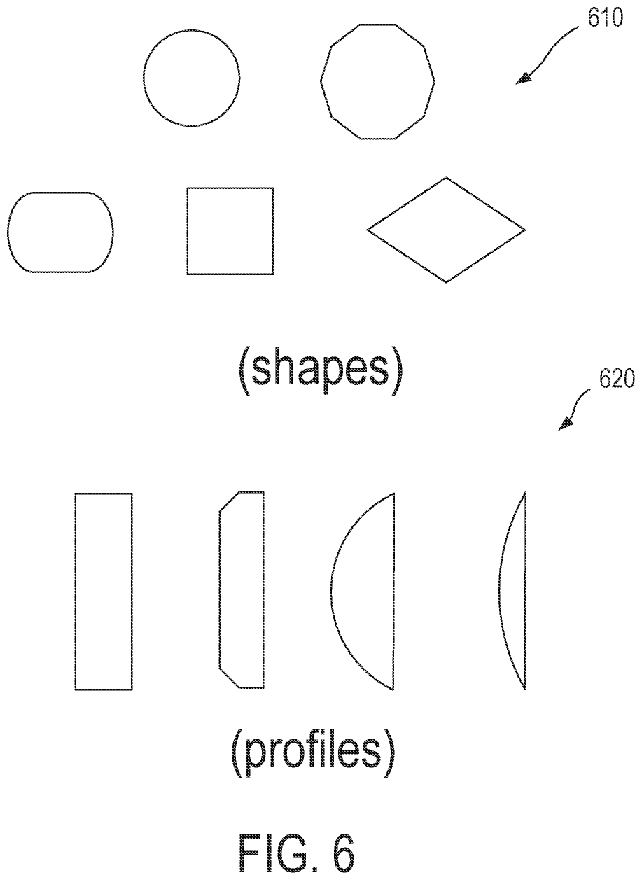

As shown in FIG. 6, scenting systems can be provided in any of a variety of shapes 610 (top plan view) or profiles 620 (side view). In some cases, shapes and/or profile may have rounded or smoothed edges (when viewed from the top and/or the side), which may enhance the comfort of the person wearing the mask.

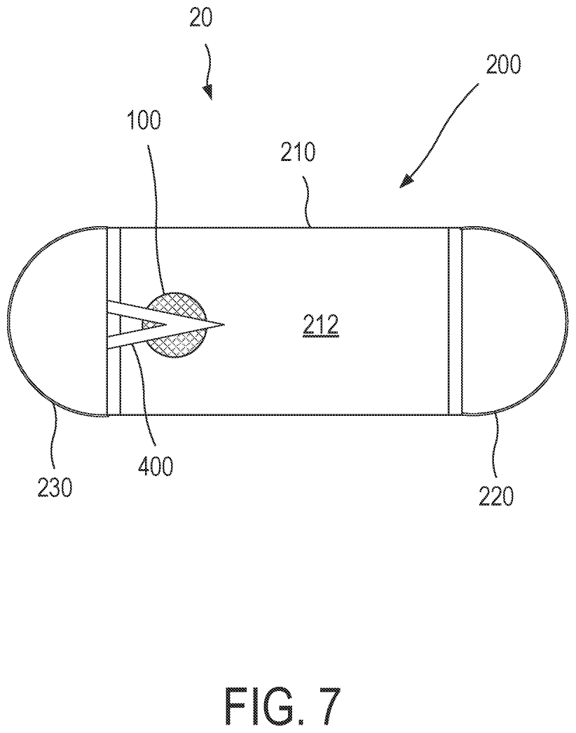

FIG. 7 depicts aspects of an exemplary mask system 20 for providing a scent to a user, according to embodiments of the present invention. A mask system 20 can include a mask 200 and a scenting assembly 100. With continuing reference to FIG. 7, in some embodiments, a scenting system 100 can be coupled with or otherwise fixed relative to a mask panel, by using a clip 400. In such cases, the scenting system 100 may or may not include an adhesive portion or a backing section. For example, the scenting system 100 may include the scented portion and the clip. The clip 400 can be made of a biodegradable material. In some cases, the clip can be made from wood or cardboard. In some cases, the clip 400 may resemble a hair clip or a barrette.

The scenting system can be used to cover up or eliminate foul or unwanted odors while working with a mask in place. The scenting system may include a small attachment that adheres to any nose/mouth covering and emits a scent. To use the scenting system, an individual can tear open the packaging, remove the scenting system, and place the sticky side of scenting system to the facemask. For the strongest scent, the scenting system can be placed on the inside or interior surface of the mask panel. In some embodiments, the scenting system can be placed on the exterior surface of the mask panel.

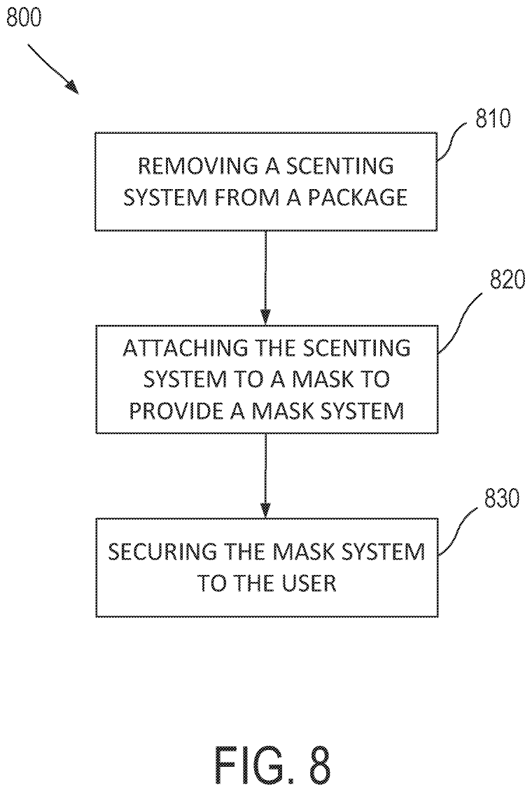

FIG. 8 depicts aspects of a method 800 for providing a scent to a user. The methods 800 can include removing a scenting system from a package, as indicated in step 810, attaching the scenting system to a mask to provide a mask system, as indicated in step 820, and securing the mask system to the user, as indicated in step 830, such that when the mask system is worn by the user, aromatic molecules of the scented substance exit an absorbent patch of the scenting system and flow into the user's nose without the scented substance touching the user's skin.

Although embodiments of the present invention have been explained in relation to one or more preferred embodiments, it is to be understood that many other possible modifications and variations can be made without departing from the spirit and scope of the invention.

All features of the described systems and devices are applicable to the described methods mutatis mutandis, and vice versa. Embodiments of the present invention encompass kits having systems for scenting masks as disclosed herein. In some embodiments, the kit includes one or more systems for scenting a mask, along with instructions for using the system for example according to any of the methods disclosed herein.

Although the foregoing invention has been described in some detail by way of illustration and example for purposes of clarity of understanding, one of skill in the art will appreciate that certain changes, modifications, alternate constructions, and/or equivalents may be practiced or employed as desired, and within the scope of the appended claims. In addition, each reference provided herein in incorporated by reference in its entirety to the same extent as if each reference was individually incorporated by reference. Relatedly, all publications, patents, patent applications, journal articles, books, technical references, and the like mentioned in this specification are herein incorporated by reference to the same extent as if each individual publication, patent, patent application, journal article, book, technical reference, or the like was specifically and individually indicated to be incorporated by reference.

What is claimed is:

1. A mask system for providing a scent to a user, the mask system comprising:
a mask having an interior surface, an exterior surface, a right ear loop, and a left ear loop; and
a scenting assembly having a scented portion and an adhesive portion, the scented portion comprising an absorbent patch impregnated with a scented substance,
wherein the adhesive portion of the scenting system is attached with the interior surface of the mask, such that when the mask system is worn by the user, aromatic molecules of the scented substance exit the absorbent patch and flow into the user's nose without the scented substance touching the user's skin.

2. The system according to claim 1, wherein the scented substance comprises an essential oil.

3. The system according to claim 1, wherein the scented substance comprises an orange scent.

4. The system according to claim 1, wherein the scented substance comprises limonene.

5. The system according to claim 1, wherein the scented substance comprises D-limonene.

6. The system according to claim 1, wherein the scented substance comprises a material having a grapefruit scent.

7. The system according to claim 1, wherein the scented substance comprises a material having a peppermint scent.

8. The system according to claim 1, wherein the scented substance comprises menthol.

9. The system according to claim 1, wherein the scented substance comprises menthone.

10. The system according to claim 1, wherein the scented substance comprises a material having a eucalyptus scent.

11. The system according to claim 1, wherein the scented substance comprises eucalyptol.

12. The system according to claim 1, wherein the scented substance comprises alpha-terpineol.

13. The system according to claim 1, wherein the scented substance comprises a floral scent.

14. The system according to claim 1, wherein the scented substance comprises a plant-based scent.

15. The system according to claim 1, wherein the scented substance is present in the absorbent patch in a predetermined amount.

16. A method of providing a scent to a user, the method comprising:
removing a scenting system from a package, the scenting system comprising an interior scented portion, a backing section, and an adhesive portion disposed between the interior scented portion and the backing section, wherein the interior scented portion comprises an absorbent patch impregnated with a scented substance;
removing the backing section from the adhesive portion of the scenting system;
contacting the adhesive portion of the scenting system to an interior surface of a mask, the mask comprising a right ear loop and a left ear loop; and
placing the right ear loop about the user's right ear and the left ear loop about the user's right ear, with the interior surface of the mask facing toward the user's face, such that aromatic molecules of the scented substance exit the absorbent patch and flow into the user's nose without the scented substance touching the user's skin, thereby providing the scent to the user.

17. The method according to claim 16, wherein the scented substance comprises an essential oil.

18. The method according to claim 16, wherein the scented substance is present in the absorbent patch in a predetermined amount.

19. A scenting system for a face mask, comprising:
a scented portion;
a backing portion; and
an adhesive portion disposed between the scented portion and the backing portion.

20. The system according to claim 19, wherein the scented portion comprises an absorbent patch impregnated with a scented substance, and wherein the scented substance comprises a material selected from the group consisting of an orange scent, a grapefruit scent, a peppermint scent, and a eucalyptus scent.
